(19) United States
(12) Patent Application Publication
(10) Pub. No.: US 2025/0141843 A1
(43) Pub. Date: May 1, 2025

(54) Communication Devices and Methods Therein for Facilitating IPSEC Communications

(71) Applicant: Telefonaktiebolaget LM Ericsson (publ), Stockholm (SE)

(72) Inventors: Daiying Liu, Beijing (CN); Daniel Migault, Montreal (CA); Renwang Liu, Beijing (CN); Congjie Zhang, Beijing (CN)

(21) Appl. No.: 18/835,847

(22) PCT Filed: Feb. 22, 2022
(86) PCT No.: PCT/CN2022/077258

§ 371 Date: Aug. 5, 2024

(51) Int. Cl. H04L 9/40

(52) U.S. Cl. CPC H04L 63/0272; H04L 63/0485; H04L 63/164

(57) ABSTRACT

The present disclosure provides a method (200) performed by a first communication device. The method (200) includes: receiving (210), from a second communication device, an Encapsulating Security Payload, ESP, packet that is an initial fragment; calculating (220), from the ESP packet, a Maximum Transmission Unit, MTU, in a path from the second communication device to the first communication device; and notifying (230) the second communication device of the calculated MTU.

### TECHNICAL FIELD

The present disclosure relates to communication technology, and more particularly, to a communication device and method therein for facilitating Internet Protocol (IP) Security (IPsec) communications.

### BACKGROUND

IPsec provides confidentiality, data integrity, access control, and data source authentication to IP datagrams. These services are provided by maintaining shared state between the source and the sink of an IP datagram. This state defines, among other things, the specific services provided to the datagram, which cryptographic algorithms will be used to provide the services, and the keys used as input to the cryptographic algorithms.

The Internet Engineering Task Force (IETF) Request for Comments (RFC) 7296, Internet Key Exchange Protocol Version 2 (IKEv2), which is incorporated herein by reference in its entirety, describes version 2 of the Internet Key Exchange (IKE) protocol. IKE is a component of IPsec used for performing mutual authentication and establishing and maintaining Security Associations (SAs).

IKE performs mutual authentication between two parties and establishes an IKE Security Association (SA) that includes shared secret information that can be used to efficiently establish SAs (referred to as child SAs) for Encapsulating Security Payload (ESP) or Authentication Header (AH) and a set of cryptographic algorithms to be used by the SAs to protect the traffic that they carry.

IETF RFC 8900, IP Fragmentation Considered Fragile, which is incorporated herein by reference in its entirety, describes IP fragmentation and reassembly. Fragmentation of an internet datagram is necessary when it originates in a local network that allows a large packet size and must traverse a local network that limits packets to a smaller size to reach its destination. The IP fragmentation and reassembly procedure needs to be able to break a datagram into an almost arbitrary number of pieces that can be later reassembled.

For example, when IP traffic is to traverse an untrusted network, IPsec is needed to protect the transmission security. However, the Maximum Transmission Unit (MTU) of each router in the untrusted network is unknown to, and cannot be modified by, IPsec applications at both ends. From the application perspective, an application does not know whether it needs to change the packet size, and if so, what the proper packet size is to change to. Hence, ESP packets may be fragmented when traversing the untrusted network.

IP fragmentation could bring many defects. The following are some of them as described in RFC 8900. IP fragmentation consumes more Central Processing Unit (CPU) and Random Access Memory (RAM) for reassembling but the router has limited RAM. When reassemble the clothing it needs to put all the unused packets into the buffer and queue them up which has a great influence on the system; For IPsec it is very serious because IPsec cares the performance. If any fragment is dropped during transmission, all data needs to be retransmitted; For example a large packet is divided into 7 small packets for transmission and if any small packet is dropped the 7 packets will be retransmitted. A large packet will become initial fragment (the first packet) and non-initial fragment (the second and subsequent packets) after fragmentation. Non-initial fragment packets contain only three layers of information (Layer 1 to Layer 3). If out-of-order occurs during data transmission, some firewalls will discard the first packet received if it is a non-initial fragment.

### SUMMARY

The IP fragmentation may be even more problematic in an IKE over Network Address Translation (NAT) scenario. FIGS. 1A-1C show packet formats used in the IKE over NAT scenario. In particular, FIG. 1A shows a UDP-encapsulated packet format, FIG. 1B shows a packet format of an initial fragment in the case of fragmentation, and FIG. 1C shows a packet format of a non-initial fragment in the case of fragmentation. In the IKE over NAT scenario, the protocol identifier (ID) in the IP header is UDP (17). As shown in FIG. 1A, an IP header is followed by an UDP header and then an ESP header. However, in the case of fragmentation, only the initial fragment carries the correct UDP header, as shown in FIG. 1B, and each non-initial fragment carries the IP payload following the IP header, as shown in FIG. 1C. Therefore, the non-initial fragment may be incorrectly identified as a packet of a different protocol (e.g., when the payload data following the IP header is the same as its protocol ID), and thus be incorrectly processed by a router on the transmission path, which may cause traffic interruption.

It is an object of the present disclosure to provide communication devices and methods therein, capable of solving, or at least mitigating, the above problem.

According to a first aspect of the present disclosure, a method performed by a first communication device is provided. The method includes: receiving, from a second communication device, an ESP packet that is an initial fragment;

calculating, from the ESP packet, an MTU in a path from the second communication device to the first communication device; and notifying the second communication device of the calculated MTU.

In an embodiment, the operation of calculating may include: calculating the MTU as a payload length of the ESP packet.

In an embodiment, the operation of notifying may include: transmitting, to the second communication device, an IKEv2 message indicating the MTU.

In an embodiment, the IKEv2 message may be an IKEv2 INFORMATIONAL message.

According to a second aspect of the present disclosure, a first communication device is provided. The first communication device includes a communication interface, a processor and a memory. The memory contains instructions executable by the processor whereby the first communication device is operative to perform the method according to the above first aspect.

According to a third aspect of the present disclosure, a computer program is provided. The computer program contains instructions which, when executed by a processor of a first communication device, configure the first communication device to perform the method according to the above first aspect.

According to a fourth aspect of the present disclosure, a computer-readable storage medium is provided. The computer-readable storage medium has computer-readable instructions stored thereon. The computer-readable instructions, when executed by a processor of a first communication device, configure the first communication device to perform the method according to the above first aspect.

According to a fifth aspect of the present disclosure, a method performed by a second communication device is provided. The method includes: receiving, from a first communication device, a notification of an MTU in a path from the second communication device to the first communication device; receiving, from a packet sender, an original IP packet to be transmitted to the first communication device in the path; calculating, for the original IP packet, a packet size with an additional ESP header and an additional tunnel header; and when the packet size exceeds the MTU: informing the packet sender that the original packet is too big; or fragmenting the original IP packet based on the MTU.

In an embodiment, the operation of informing may include: transmitting, to the packet sender, an Internet Control Message Protocol (ICMP) message indicating that the original packet is too big.

In an embodiment, the ICMP message may indicate “Destination Unreachable” with Type 3 and Code 4 for IP version 4 (IPv4), or “Too Big” for IP version 6 (IPv6).

In an embodiment, the original IP packet may be fragmented such that each resulting fragment, with an additional ESP header and an additional tunnel header, has a size smaller than or equal to the MTU.

In an embodiment, the method may further include, subsequent to the operation of fragmenting: encrypting and encapsulating each resulting fragment for transmission to the first communication device.

In an embodiment, the notification may include an IKEv2 message indicating the MTU.

In an embodiment, the IKEv2 message may be an IKEv2 INFORMATIONAL message.

According to a sixth aspect of the present disclosure, a second communication device is provided. The second communication device includes a communication interface, a processor and a memory. The memory contains instructions executable by the processor whereby the second communication device is operative to perform the method according to the above second aspect.

According to a seventh aspect of the present disclosure, a computer program is provided. The computer program contains instructions which, when executed by a processor of a second communication device, configure the second communication device to perform the method according to the above second aspect.

According to an eighth aspect of the present disclosure, a computer-readable storage medium is provided. The computer-readable storage medium has computer-readable instructions stored thereon. The computer-readable instructions, when executed by a processor of a second communication device, configure the second communication device to perform the method according to the above second aspect.

With the embodiments of the present disclosure, when a first communication device receives, from a second communication device, an ESP packet that is an initial fragment, it can calculate, from the ESP packet, an MTU in a path from the second communication device to the first communication device, and notify the second communication device of the calculated MTU. Upon receiving the notification of the MTU, the second communication device can calculate, for an original IP packet received from a packet sender, a packet size with an additional ESP header and an additional tunnel header, and when the packet size exceeds the MTU, inform the packet sender that the original packet is too big; or fragment the original IP packet based on the MTU. In this way, fragmentation of ESP packets along the path can be prevented, such that incorrect processing of fragments as described above can be avoided.

### BRIEF DESCRIPTION OF THE DRAWINGS

The above and other objects, features and advantages will be more apparent from the following description of embodiments with reference to the figures, in which:

FIGS. 1A-1C are schematic diagrams showing packet formats used in the IKE over NAT scenario;

FIG. 2 is a flowchart illustrating a method according to an embodiment of the present disclosure;

FIG. 3 is a schematic diagram showing an IP header format;

FIGS. 4A and 4B show a message format of a notify message according to an embodiment of the present disclosure;

FIG. 5 is a flowchart illustrating a method according to another embodiment of the present disclosure;

FIG. 6 is a block diagram of a first communication device according to an embodiment of the present disclosure; and

FIG. 7 is a block diagram of a second communication device according to an embodiment of the present disclosure.

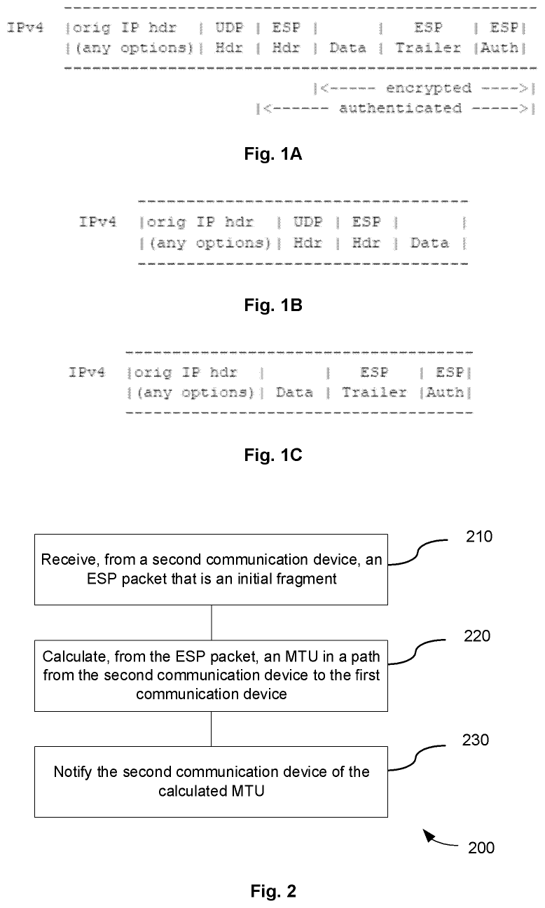

### DETAILED DESCRIPTION

As used herein, the term “communication device” refers to any device or node in a wired or wireless communication network. For example, a communication device may be a network device or node, such as an access network node or a core network node. Alternatively, a communication device may be a terminal device, such as a User Equipment (UE), that can access a communication network.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

FIG. 2 is a flowchart illustrating a method 200 according to an embodiment of the present disclosure. The method 200 can be performed by a first communication device.

At block 210, the first communication device receives, from a second communication device, an ESP packet that is an initial fragment.

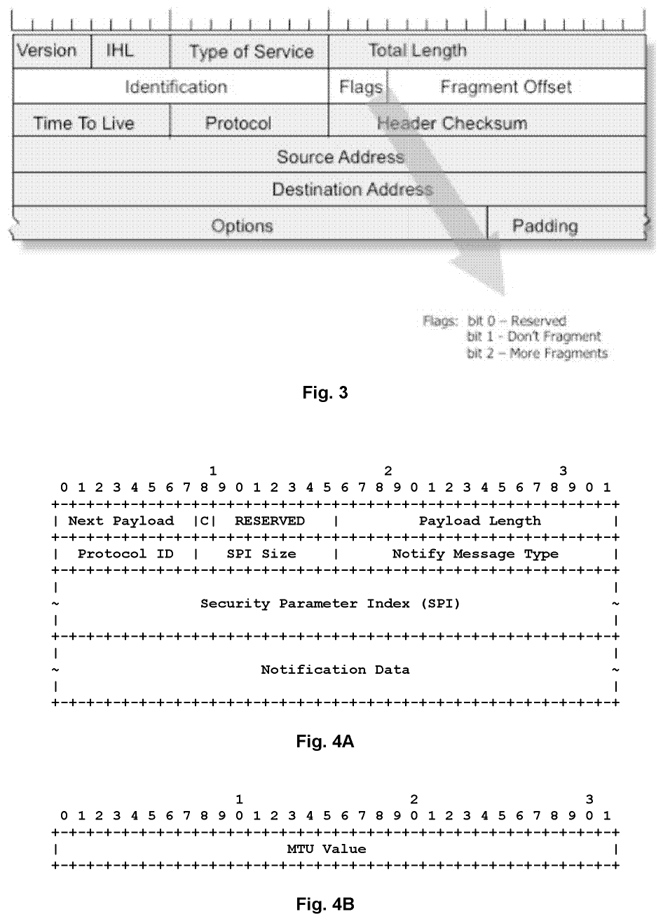

In particular, upon receiving an ESP packet, the first communication device can determine whether it is a fragment, and if so, whether it is an initial fragment. FIG. 3 shows an IP header format. As shown, the packet is an initial fragment when the “More Fragments (MF)” bit in the “Flags” field is set and the “Fragment Offset” field has a value of 0.

At block 220, the first communication device calculates, from the ESP packet, an MTU in a path from the second communication device to the first communication device. Here, the MTU may be e.g., a minimum value among MTUs of respective nodes in the path.

For example, the MTU may be calculated as a payload length of the ESP packet.

At block 230, the first communication device notifies the second communication device of the calculated MTU.

For example, in the block 230, the first communication device can transmit, to the second communication device, an IKEv2 message indicating the MTU.

In particular, the IKEv2 message may be an IKEv2 INFORMATIONAL message, with an “ALLOWED_MTU” notify type to inform the second communication device of the allowed MTU for the current IKEv2 session. For example, the first communication device can send a message containing HDR, SK {N[ALLOWED_MTU]} to the second communication device. The payloads contained in the message are indicated by names as listed below.

| Notation | Payload |
|---|---|
| HDR | IKE header (not a payload) |
| N | Notify |
| SK | Encrypted and Authenticated |

FIGS. 4A and 4B show a message format of a notify message for carrying the above “ALLOWED_MTU” notification. Here, the Notify Message Type ALLOWED_MTU is defined as follows:

| Value | Notify Message Type |
|---|---|
| 16448 | ALLOWED_MTU |

The fields in FIG. 4A can be defined as follows:
Next Payload—N(41), indicates this is Notify payload;
C=0—recipient to skip this payload if it does not understand the payload type code;
Protocol ID—this field must contain either (2) to indicate AH or (3) to indicate ESP;
SPI Size—length in octets of the child SA SPI;
Notify Message Type—ALLOWED_MTU (16448)
Notification data for ALLOWED_MTU—4 octets, as shown in FIG. 4B.

Referring to FIG. 4B, the “MTU Value” indicates the allowed MTU on the current forwarding path for the current IKEv2 session.

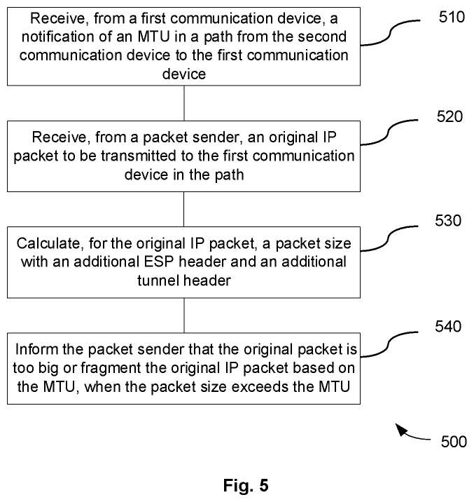

FIG. 5 is a flowchart illustrating a method 500 according to another embodiment of the present disclosure. The method 500 can be performed by a second communication device.

At block 510, the second communication device receives, from a first communication device, a notification of an MTU, in a path from the second communication device to the first communication device. Here, the MTU may be e.g., a minimum value among MTUs of respective nodes in the path.

In an example, the notification may include an IKEv2 message indicating the MTU. The IKEv2 message may be an IKEv2 INFORMATIONAL message, with an “ALLOWED_MTU” notify type, as described above in connection with FIGS. 4A and 4B.

At block 520, the second communication device receives, from a packet sender (which may be an application running on the second communication device or another device), an original IP packet to be transmitted to the first communication device in the path.

At block 530, the second communication device calculates, for the original IP packet, a packet size with an additional ESP header and an additional tunnel header.

At block 540, when the packet size exceeds the MTU, the second communication device can inform the packet sender that the original packet is too big. In an example, the second communication device can transmit, to the packet sender, an ICMP message indicating that the original packet is too big. For example, the ICMP message may indicate “Destination Unreachable” with Type 3 and Code 4 (fragmentation needed and DF (Don't Fragment) bit set) for IPV4, or “Too Big” for IPv6. Upon receiving the ICMP message, the packet sender can then reduce the IP packet size, following the ICMP protocol.

Alternatively, at block 540, when the packet size exceeds the MTU, the second communication device can fragment the original IP packet based on the MTU. For example, the original IP packet is fragmented such that each resulting fragment, with an additional ESP header and an additional tunnel header, has a size smaller than or equal to the MTU. Then, the second communication device can encrypt and encapsulate each resulting fragment for transmission to the first communication device. Thus, the fragments will not be fragmented by any node along the path. Upon receiving the fragments, the first communication device simply follows legacy processes to decapsulate and decrypt the fragments and forward them to a corresponding application for reassembly.

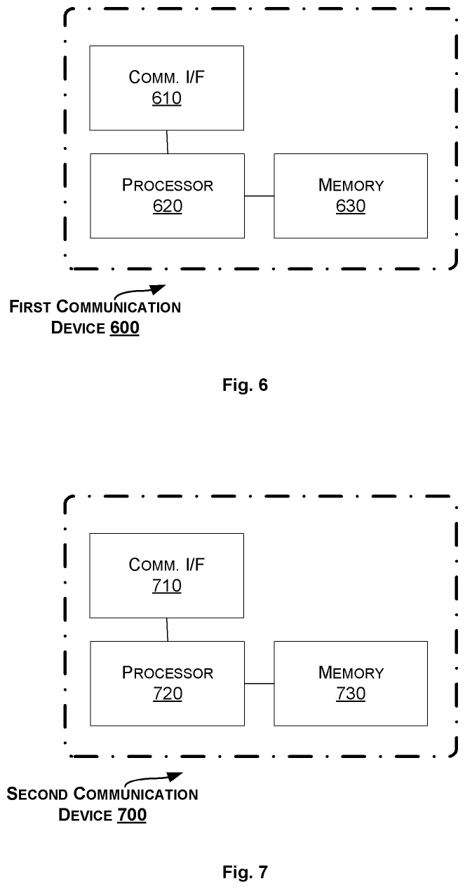

FIG. 6 is a block diagram of a first communication device 600 according to an embodiment of the present disclosure.

The first communication device 600 includes a communication interface 610, a processor 620 and a memory 630. The memory 630 may contain instructions executable by the processor 620 whereby the first communication device 600 is operative to perform the actions, e.g., of the procedure described earlier in conjunction with FIG. 2. Particularly, the memory 630 may contain instructions executable by the processor 620 whereby the first communication device 600 is operative to: receive, from a second communication device, an ESP packet that is an initial fragment; calculate, from the ESP packet, an MTU in a path from the second communication device to the first communication device; and notify the second communication device of the calculated MTU.

In an embodiment, the operation of calculating may include: calculating the MTU as a payload length of the ESP packet.

In an embodiment, the operation of notifying may include: transmitting, to the second communication device, an IKEv2 message indicating the MTU.

In an embodiment, the IKEv2 message may be an IKEv2 INFORMATIONAL message.

FIG. 7 is a block diagram of a second communication device 700 according to an embodiment of the present disclosure.

The second communication device 700 includes a communication interface 710, a processor 720 and a memory 730. The memory 730 may contain instructions executable by the processor 720 whereby the second communication device 700 is operative to perform the actions, e.g., of the procedure described earlier in conjunction with FIG. 5. Particularly, the memory 730 may contain instructions executable by the processor 720 whereby the second communication device 700 is operative to: receiving, from a first communication device, a notification of an MTU in a path from the second communication device to the first communication device; receiving, from a packet sender, an original IP packet to be transmitted to the first communication device in the path; calculating, for the original IP packet, a packet size with an additional ESP header and an additional tunnel header; and when the packet size exceeds the MTU: informing the packet sender that the original packet is too big; or fragmenting the original IP packet based on the MTU.

In an embodiment, the operation of informing may include: transmitting, to the packet sender, an ICMP message indicating that the original packet is too big.

In an embodiment, the ICMP message may indicate “Destination Unreachable” with Type 3 and Code 4 for IPV4, or “Too Big” for IPV6.

In an embodiment, the original IP packet may be fragmented such that each resulting fragment, with an additional ESP header and an additional tunnel header, has a size smaller than or equal to the MTU.

In an embodiment, the memory 730 may further contain instructions executable by the processor 720 whereby the second communication device 700 is operative to, subsequent to the operation of fragmenting: encrypt and encapsulate each resulting fragment for transmission to the first communication device.

In an embodiment, the notification may include an IKEv2 message indicating the MTU.

In an embodiment, the IKEv2 message may be an IKEv2 INFORMATIONAL message.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 620 causes the first communication device 600 to perform the actions, e.g., of the procedure described earlier in conjunction with FIG. 2, or code/computer readable instructions, which when executed by the processor 720 causes the second communication device 700 to perform the actions, e.g., of the procedure described earlier in conjunction with FIG. 5.

The computer program product may be configured as a computer program code structured in computer program modules. The computer program modules could essentially perform the actions of the flow illustrated in FIG. 2 or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-17. (canceled)

18. A method performed by a first communication device, comprising:
receiving, from a second communication device, an Encapsulating Security Payload (ESP) packet that is an initial fragment;
calculating, from the ESP packet, a Maximum Transmission Unit (MTU) in a path from the second communication device to the first communication device; and
notifying the second communication device of the calculated MTU.

19. The method of claim 18, wherein said calculating comprises calculating the MTU as a payload length of the ESP packet.

20. The method of claim 18, wherein said notifying comprises transmitting, to the second communication device, an Internet Key Exchange version 2 (IKEv2) message indicating the MTU.

21. The method of claim 20, wherein the IKEv2 message is an IKEv2 INFORMATIONAL message.

22. A method performed by a second communication device, comprising:
receiving, from a first communication device, a notification of a Maximum Transmission Unit (MTU) in a path from the second communication device to the first communication device;
receiving, from a packet sender, an original Internet Protocol (IP) packet to be transmitted to the first communication device in the path;
calculating, for the original IP packet, a packet size with an additional Encapsulating Security Payload (ESP) header and an additional tunnel header; and
in response to the packet size exceeding the MTU, informing the packet sender that the original packet is too big, or fragmenting the original IP packet based on the MTU.

23. The method of claim 22, wherein said informing comprises transmitting, to the packet sender, an Internet Control Message Protocol (ICMP) message indicating that the original packet is too big.

24. The method of claim 23, wherein the ICMP message indicates “Destination Unreachable” with Type 3 and Code 4 for IP version 4, IPv4, or “Too Big” for IP version 6, IPv6.

25. The method of claim 22, wherein the original IP packet is fragmented such that each resulting fragment, with an additional ESP header and an additional tunnel header, has a size smaller than or equal to the MTU.

26. The method of claim 25, further comprising, subsequent to said fragmenting, encrypting and encapsulating each resulting fragment for transmission to the first communication device.

27. The method of claim 22, wherein the notification comprises an Internet Key Exchange version 2 (IKEv2) message indicating the MTU.

28. The method of claim 27, wherein the IKEv2 message is an IKEv2 INFORMATIONAL message.

29. A first communication device comprising:
a communication interface configured for communicating with a second communication device;
a memory containing instructions; and
a processor configured to execute the instructions and thereby control the first communication device to:
receive, from the second communication device, an Encapsulating Security Payload (ESP) packet that is an initial fragment;
calculate, from the ESP packet, a Maximum Transmission Unit (MTU) in a path from the second communication device to the first communication device; and
notify the second communication device of the calculated MTU.

30. A second communication device comprising:
a communication interface configured for communication with a first communication device;
a memory containing instructions; and
a processor configured to execute the instructions and thereby control the second communication device to:
receive, from the first communication device, a notification of a Maximum Transmission Unit (MTU) in a path from the second communication device to the first communication device;
receive, from a packet sender, an original Internet Protocol (IP) packet to be transmitted to the first communication device in the path;
calculate, for the original IP packet, a packet size with an additional Encapsulating Security Payload (ESP) header and an additional tunnel header; and
in response to the packet size exceeding the MTU, inform the packet sender that the original packet is too big, or fragment the original IP packet based on the MTU.
